(19) United States
(12) Patent Application Publication
(10) Pub. No.: US 2021/0073830 A1
(43) Pub. Date: Mar. 11, 2021

(54) COMPUTERIZED COMPETITIVENESS ANALYSIS

(71) Applicant: International Business Machines Corporation, Armonk, NY (US)

(72) Inventors: Michelle Morales, Franklin Square, NY (US); Sheema Usmani, White Plains, NY (US); Biplav Srivastava, Rye, NY (US); Mariana Cecilia Bernagozzi, White Plains, NY (US); Amir Sabet Sarvestani, New York, NY (US); Lee Case Klippel, New York, NY (US)

(21) Appl. No.: 16/564,252

(22) Filed: Sep. 9, 2019

(51) Int. Cl. G06Q 30/02; G06F 17/27; G06Q 30/06

(52) U.S. Cl. CPC G06Q 30/0201; G06F 17/2785; G06Q 30/0283; G06Q 30/0629; G06Q 30/0282

(57) ABSTRACT

A computer receives a product or service name for competitive analysis. The computer determines a plurality of dimensions for competitive analysis of the product or service. The computer collects product or service data regarding a product or service associated with the product or service name and one or more competing products or services. The computer performs, using the plurality of dimensions, natural language processing on the collected product or service data. The computer calculates, using results of the natural language processing, a product or service competitiveness score. The computer outputs the product or service competitiveness score.

### BACKGROUND

The present disclosure relates to product and/or service analysis, and more specifically, to computer implemented analysis of product and/or service competitiveness.

Competitive analysis of products and/or services can be a useful tactic used by a business or other entity to find out how its competitors' products and/or services are performing. This can be useful to understand what type of threat these products and/or services pose to the business' financial well-being.

### SUMMARY

Disclosed herein are embodiments of a method, system, and computer program product for competitive analysis. A computer receives a product or service name for competitive analysis. The computer determines a plurality of dimensions for competitive analysis of the product or service. The computer collects product or service data regarding a product or service associated with the product or service name and one or more competing products or services. The computer performs, using the plurality of dimensions, natural language processing on the collected product or service data. The computer calculates, using results of the natural language processing, a product or service competitiveness score. The computer outputs the product or service competitiveness score.

According to various embodiments described herein, a system may be provided comprising a memory and a processor for implementing the above-described method operations. Furthermore, various embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain a mechanism for storing, communicating, propagating or transporting the program for use, by, or in connection, with the instruction execution system, apparatus, or devices described herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example method for computerized analysis of product and/or service competitiveness, in accordance with embodiments of the present disclosure.

FIG. 2 depicts an example output of a computerized analysis of product and/or service competitiveness in the form of a sorted stream graph, in accordance with embodiments of the present disclosure.

FIG. 3 illustrates a block diagram of a computer system, in accordance with some embodiments of the present disclosure.

FIG. 4 illustrates a block diagram of a network environment in which some embodiments of the present disclosure can be implemented.

FIG. 5 depicts a cloud computing environment according to some embodiments of the present disclosure.

FIG. 6 depicts abstraction model layers according to some embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to product and/or service analysis, more particular aspects relate to computer implemented analysis of product and/or service competitiveness over multiple dimensions. While the present disclosure is not necessarily limited to such applications, various aspects of the disclosure may be appreciated through a discussion of various examples using this context.

Competitive analysis of products and/or services can be a useful tactic used by a business or other entity to find out how its competitors' products and/or services are performing. An entity can perform competitive analysis of products and/or services in order to determine how its products and/or services compare to competitors or determine a market opportunity by analyzing a competitive field in which the entity seeks to expand into. These analyses can be useful to understand what type of threat these products and/or services pose to the business' financial well-being and/or opportunities to expand or improve the business' offerings. Staying up-to-date on a product or service's competitiveness can be a costly and difficult task because of the dynamic nature of today's businesses. Product managers, sellers, marketers, and others can spend time and effort analyzing hundreds or thousands of reviews, articles, and other forms of online and offline content, aiming to understand their competition and determine their product or service's competitiveness. Due to the difficulty of keeping up-to-date on research, many teams are unable to capture the full extent of their product or service health compared to alternative solutions on the market.

Embodiments of the present disclosure provide for a method, system, and computer program product for computerized analysis of product and/or service competitiveness. A competitive analysis application can receive a product or service name and one or more dimensions of the product or service to include in the analysis. The competitive analysis application can collect product and or service data regarding the received product or service and competitor products and services. This data can be analyzed using natural language processing. Keywords and keyword sentiment values can be extracted using natural language processing (NLP) techniques. The keywords and dimensions can be converted/mapped to word vector representations and distances between the keywords and dimensions can be calculated. The keywords can be assigned to the dimensions using distance between the vectors. The competitive analysis application can calculate the average sentiment for each dimension. The competitive analysis application can calculate a product or service's competitiveness, including by using a competitiveness metric based upon the sentiment values. The competitive analysis application can output the product or service competitiveness to a user. Such a competitive analysis application can be extensible to any type of offering, use extensible dimensions for comparison of offerings, use multiple data sources, including structured and unstructured, calculate competitive comparison and its change over time, visualize comparison value and its evolution, and measure competitiveness with specified metrics.

A computerized analysis of product and/or service competitiveness as described herein can provide advantages over prior methods of performing competitiveness analysis. A human researcher performing competitiveness analysis may need to read thousands of product reviews, keep track of topics or themes of interest for each product, determine whether the mentions of these topics or themes are positive or negative feedback, and compile this data into a decision of whether a product is more or less competitive. Because of the manual and unstructured nature of this process and the various determinations made, the competitiveness analysis may include errors and may be inaccurate. Additionally, it may not be possible for numerically scoring a value for positivity/negativity of feedback or accurate compilation of the various pieces of data into a final score for a decision of whether a product or service is more or less competitive.

In contrast, the computerized analysis of product and/or service competitiveness as described herein can perform these analyses using natural language processing and sentiment analysis to provide for precise scoring and metrics to be used. Additionally, the time and expense of performing such tasks can be reduced. Additionally, as the number of products or services to be compared increases and the number of reviews or other data sources for these products or services increases, it becomes more difficult to scale such competitive analysis when performed manually but can be easily scaled when using the teachings presented herein. Additionally, the computerized analysis of product and/or service competitiveness as described herein can be performed on a continuous or scheduled basis resulting in up-to-date competitiveness analysis without additional effort. Furthermore, the computerized analysis of product and/or service competitiveness as described herein can be adapted to a user's requirements by performing competitiveness analysis along various dimensions that a user requires (including different dimensions for different decision makers). Additionally, performing competitive analysis using computerized analysis removes any bias or potential bias a human analyst may bring to the analysis, including, e.g., confirmation bias that one product or service will be superior or inferior. These improvements and/or advantages are a non-exhaustive list of example advantages. Embodiments of the present disclosure exist which can contain none, some, or all of the aforementioned advantages and/or improvements.

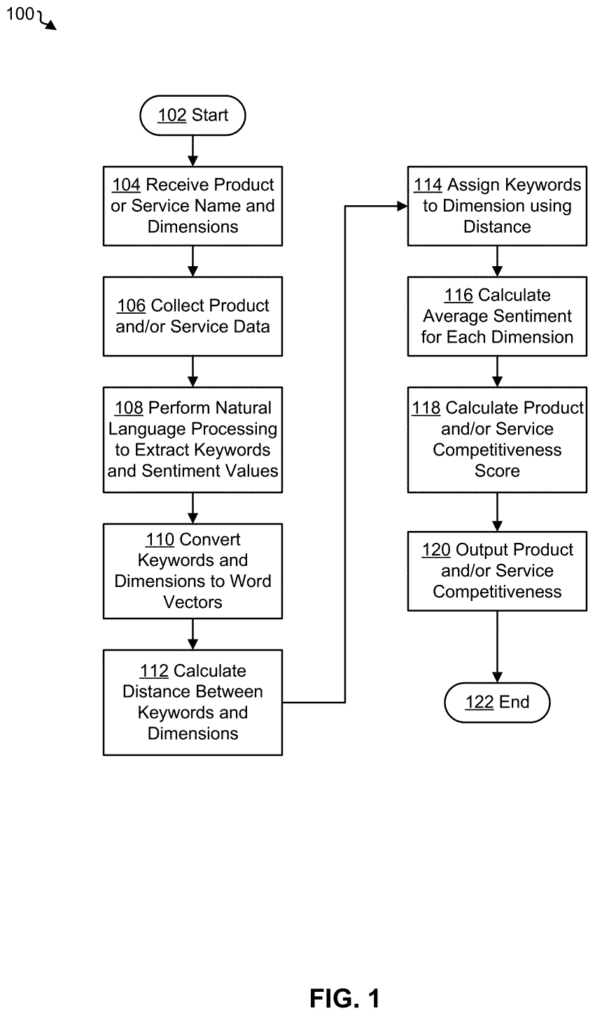

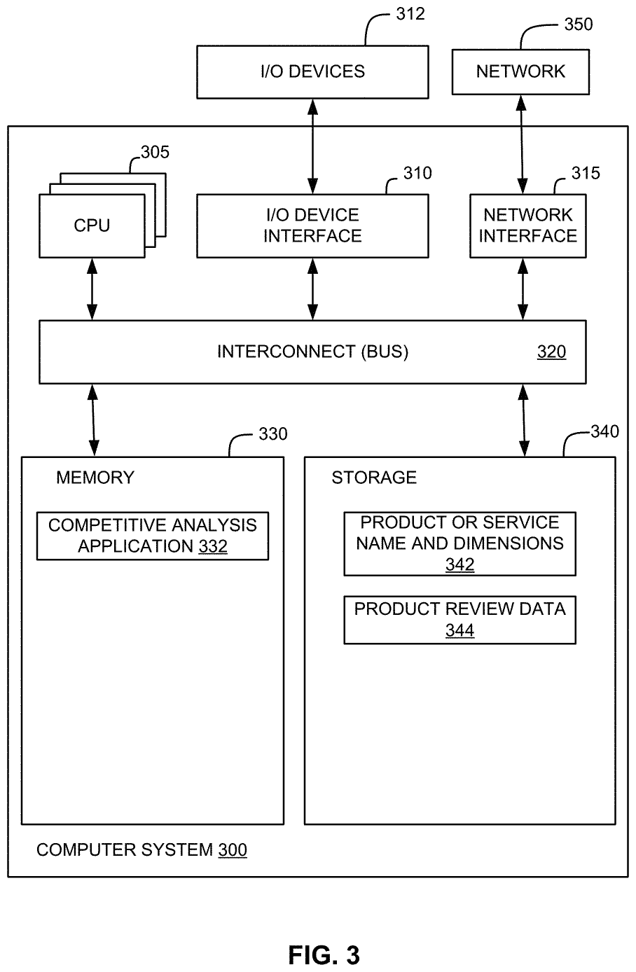

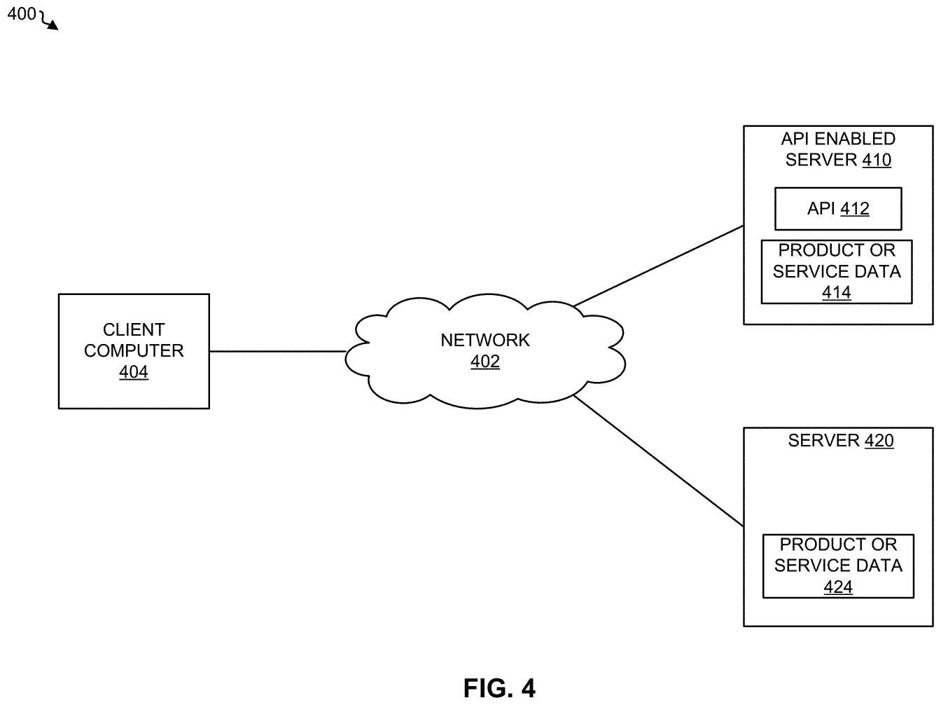

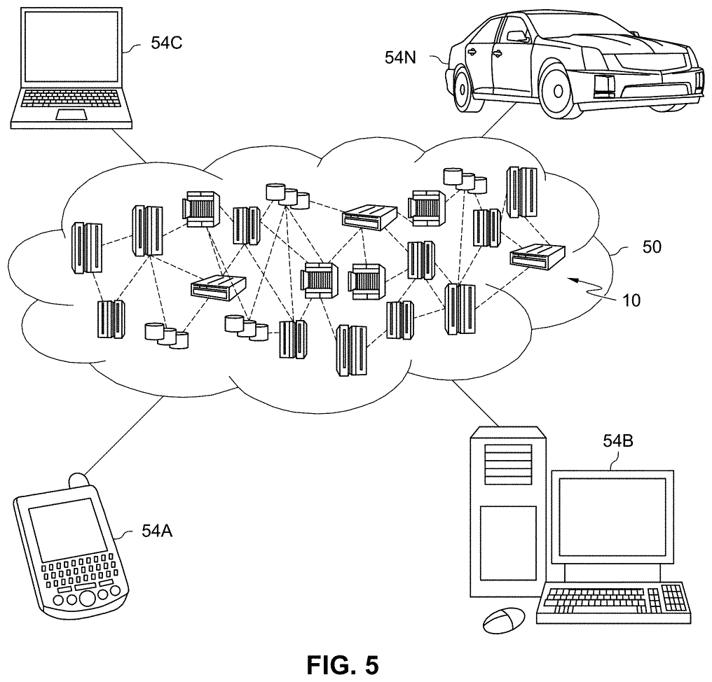

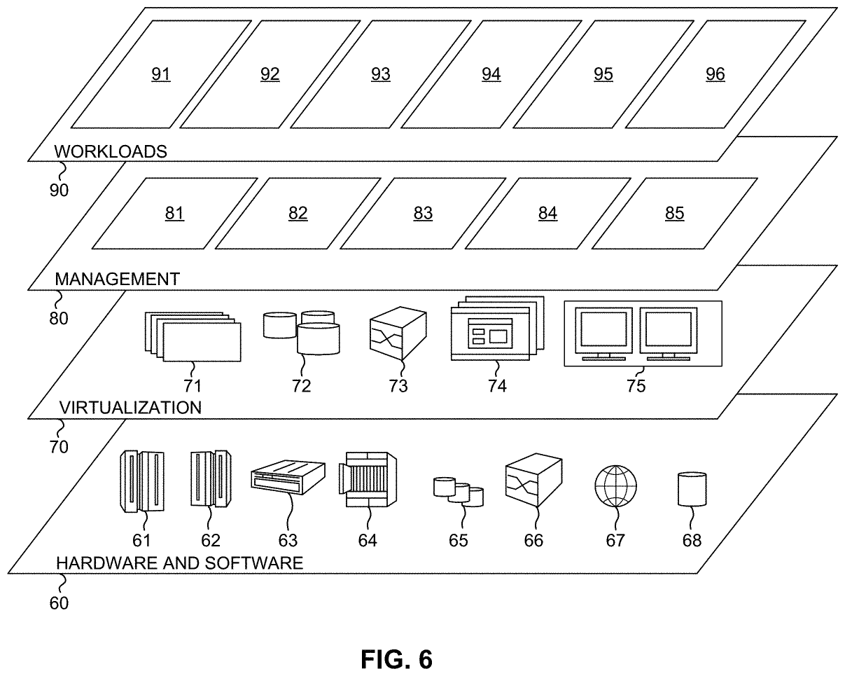

Referring now to FIG. 1, depicted is an example method 100 for computerized analysis of product and/or service competitiveness, in accordance with embodiments of the present disclosure. Method 100 can include more or fewer operations than those depicted. Method 100 can include operations in different orders than those depicted. In some embodiments, method 100 can be performed by a competitive analysis application which can be a computer program or application. Such a competitive analysis application may be run on a computer system (such as computer system 300 depicted in FIG. 3 or client computer 404 depicted in FIG. 4) and/or may be run using cloud computing technology, such as the cloud computing environment 50 depicted in FIG. 5 with abstraction model layers as depicted in FIG. 6. In some embodiments, method 100 can be performed for one product or service at a time, sequentially if more than one product or service is to be analyzed for competitiveness, and in other embodiments, method 100 can be performed for more than one product or service simultaneously. In some embodiments, method 100 can be performed continuously, by updating the competitive analysis as new data sources and/or product reviews are generated. In other embodiments, method 100 may be performed on a periodic or user scheduled basis.

From start 102, method 100 proceeds to operation 104 where the competitive analysis application receives product or service name and dimensions for which the product or service is to be compared. These can be input into the competitive analysis application by a user, such as a product manager, seller, marketer, or other user. Dimensions can also refer to key topics or themes for analysis, and example dimensions can include price, compatibility, functionality, support, and usability. In some embodiments, a user may be prompted to select from a list of possible dimensions or previously used dimensions. In some embodiments, the dimensions may be preselected for a user and/or may be automatically selected based on the type of product or service or other automated or rule-based selection criteria. In some embodiments, the dimensions can be determined via unsupervised methods, such as topic modeling, and/or augmented by user input.

At operation 106, the competitive analysis application collects product and/or service data. This collection of product and/or service data can include collecting data regarding the received product or service name from operation 104, as well as data regarding competing products and/or services. In some embodiments, a user can input the names, categories, or other information regarding competing products and/or services for which the competitive analysis application will collect data and perform competitive analysis. In other embodiments, the competitive analysis application can identify potential competing products and/or services using various techniques, such as analyzing consumer habits when viewing one product and ultimately purchasing a second product, accessing consumer review websites which identify competing products, or other techniques available to those of skill in the art.

In some embodiments, operation 106 can be performed using application programming interfaces (APIs) for various services, including websites, which aggregate data regarding products and/or services. For example, this can include using an API of a software enterprise review site when collecting product information regarding a software offering. In some embodiments, the competitive analysis application can include a list of APIs to use for collecting data. In some embodiments, the competitive analysis application can allow for user input of an API to use. In some embodiments, operation 106 can use a crawler, including in cases where an API is not available, to browse the internet or other network in order to create an index of data and aggregate data regarding the products/or services. The result of operation 106 can be an aggregation of unstructured and/or structured content from various public forums and/or websites.

At operation 108, the competitive analysis application analyzes the unstructured and/or structured content from operation 106 using natural language processing in order to extract keywords and sentiment values. The competitive analysis application can use the unstructured and/or structured data collected from the APIs or web crawlers to determine how a product is performing along the dimensions received at operation 104. Various natural language processing systems can be used for performing operation 108 including, but not limited to, IBM® Watson Natural Language Understanding.

The competitive analysis application can filter the aggregated data by product or service name to identify the relevant content for each identified product or service. Using the text from the unstructured and/or structured data as input, the competitive analysis application can perform information extraction. The competitive analysis application can extract keywords and the targeted sentiments towards those particular keywords using keyword sentiment values from the unstructured and/or structured data, which relate to each identified product or service. This can involve extracting words which are repeated across the set of unstructured and/or structured data to identify words used throughout a plurality of reviews or other information regarding the products/services.

For these keywords, sentiment values can be generated based on the context of the keywords and/or the keywords themselves. Sentiment values for the keywords can be determined in various ways, including by determining the polarity of a given keyword and/or its surroundings in the unstructured and/or structured data. The sentiment analysis can be performed using various approaches such as knowledge-based techniques, statistical methods, or hybrid approaches. Sentiment values can be a binary classification of negative or positive, or can be a more complicated value on a scale from most negative to most positive (e.g., a score from negative one to positive one or other values used to represent negative and positive sentiments). Each keyword in the unstructured and/or structured data is given a sentiment value, and these sentiment values can relate to the words which surround the keyword.

At operation 110, the competitive analysis application converts the keywords and dimensions to word vectors. This operation can vary in embodiments, but can, for example, use a skip-gram or word2vec neural network model which can learn the context in which words are used. In other embodiments, other models can be used which an represent the keywords in vector form can potentially be used. Using a skip-gram (or other) neural network model, word vectors can be trained on all of the collected natural language text in order to create a mathematical and semantic representation of words. The trained word vector model can then be used to convert the keywords, as well as the dimensions, to word vectors. Such a neural network model can represent keywords and dimensions as multidimensional continuous floating-point numbers and semantically similar or related words can be mapped to proximate points in a geometric space. Such word vectors can take the form of a row of real valued numbers where each point captures a facet of the word's meaning and semantically similar or related words can have similar vectors. As such, words that are used in similar context can be mapped to a proximate vector space.

At operation 112, the competitive analysis application calculates the distance between the keywords and the dimensions. In some embodiments, these distances can be cosine distances or cosine similarities. Cosine distances and/or cosine similarities between a keyword and a dimension can be calculated using known techniques, such as the Euclidean dot product formula. These distances can be used to determine which keywords are most related to which dimensions. Just as words that are used in similar context can be mapped to a proximate vector space, words that are related to the received dimensions can be mapped to a proximate vector space.

At operation 114, the competitive analysis application assigns keywords to a dimension using the distance calculated at operation 112. In some embodiments, each keyword can be assigned to one dimension based on having the smallest distance to that dimension compared to the distances to the other dimensions. In other embodiments, only keywords within a certain threshold distance to a dimension can be assigned to the dimension. In some embodiments, a keyword may be assigned to more than one dimension if its distance is lower than an applicable threshold value. In some embodiments, distance metrics can be used as well as tuned thresholds to assign keywords to particular dimensions.

At operation 116, the competitive analysis application calculates an average sentiment for each dimension. In some embodiments, this can be calculated by a simple average of the sentiment values of the keywords assigned to each dimension. In other embodiments, a weighted average could be used, such as one where sentiment values for keywords with a lower distance to a dimension are given greater weight than keywords with a higher distance. Such a weighted average could place greater emphasis on keywords with a clearer relationship to a given dimension.

At operation 118, the competitive analysis application calculates a product and/or service's competitiveness score. Calculating a product and/or service's competitiveness score can vary in embodiments. In some embodiments, the score can be based on multiple factors which represent perceived competitiveness, including, e.g., user numeric ratings, the volume of online content relating to the product and/or service, sentiment values for each of the received dimensions, and recency of content. In some embodiments, a user may select from a provided list of factors to score the competitiveness of a product and/or service, or may be able to provide input regarding which factors should be used in determining competitiveness for a given performance of method 100. The output of operation 118 can be a score which identifies numerically how a product and/or service is performing compared to its competitors.

In some embodiments using a numeric rating factor, this can correspond to a star rating (e.g., a four-star review on a scale from 1 to 5 stars) or similar reviewer provided indication of a rating of a product or service. Such numeric ratings can be normalized across various sources if different numeric ratings are in use. For example, if one website whose data was collected from during operation 106 uses a 5-star rating system and another website uses a rating on a scale from 1 to 10, one or more of these ranges can be adjusted to match the other (e.g., the rating on a scale of 1 to 10 can be divided by 2). In addition to strictly numeric ratings, in some embodiments, ratings in the form of letter grades (e.g., A, B, C, D, and F) can be used and, if necessary, normalized to match a star rating or other rating system. Using the various product and/or service data collected, and any normalization of numeric ratings required, an average numeric rating can be determined for each product and/or service (including the received product or service name and any competitors). In some embodiments, this numeric rating can be converted to a percentile score in order to combine it with scores from other factors. For example, a product which received an average rating of 4.2 stars out of 5, which is in the 78^{th} percentile of products, may have a numeric score of 4.2 and/or 0.78.

In some embodiments using a factor for the volume of online content relating to the product and/or service, this can take the form of a number or percentage of reviews for a given product and/or service and can be relative to the total number of reviews of all competing products and/or services. In some embodiments, a number or percentage of reviews for a given product and/or service can be calculated for each source of information (e.g., website), and an average number or percentage can be calculated from each of these values in order to avoid giving weight to a source with a skewed proportion of reviews. In some embodiments, this volume factor can be converted to a percentile score in order to combine it with scores from other factors. For example, a product which was the subject of 370 reviews included in the data set which was in the 51^{st} percentile of reviews may have a volume score of 370 and/or 0.51.

In embodiments using sentiment values for each of the received dimensions, one or more sentiment values can be used in scoring a product and/or service's competitiveness. The competitive analysis application can use the average sentiments calculated for each dimension at operation 116 to calculate an average sentiment value. In some embodiments, a user may be able to select one or more dimensions to place higher priority on, such that the average sentiment value is weighted towards the selected dimensions, while in other embodiments, this may be a simple average of the sentiment values. In some embodiments, this sentiment value factor can be converted to a percentile score in order to combine it with scores from other factors. For example, a product which had an average sentiment value on a scale from −1 to 1 of 0.22 and which was in the 87^{th} percentile of average sentiment values may have a sentiment value score of 0.22 and/or 0.87.

The competitive analysis application can calculate a score for each of the factors used and/or calculate a combined score using these factors. For example, the competitive analysis application could calculate a star rating score, a review count score, an average weighted sentiment score, and an overall score. An overall score could be an average score of the scores for each of the factors or could be a weighted average placing emphasis on one or more of the factors. Continuing with the examples from above, the overall score could be an average of the percentile scores 0.78, 0.51, and 0.87 resulting in an overall score of 0.72. In some embodiments, scores for one or more factors, or an overall score, can be generated independently for each data source and combined into one or more combined scores. Such combined scores from different data sources can be generated by simple averaging, weighted averaging by volume of content, weighted averaging by reputation of data source, or otherwise combined into combined scores.

Additionally, scores can be calculated over time based on historical data in some embodiments. For example, scores can be calculated for each three-month period over the past 18 months by separating the content of the data sources into separate groups based on the date of review or publication of the content received by the competitive analysis application. This can occur by performing separate analyses throughout method 100 for each time period and/or by aggregating data over time by performing method 100 every three months (or other set time period). A final score can be calculated using the historical data across the time horizon, giving priority to more recent data. This can be accomplished by giving weight to scores of data with more recent scores of data receiving a higher weight. For example, with a time horizon of 18 months and three-month period, linearly decreasing weights could be applied to each of the six three-month time frames beginning with the most recent three months, such that, e.g., the most recent score can be multiplied by 6, the second most recent score can be multiplied by 5, etc. and an average score calculated therefrom.

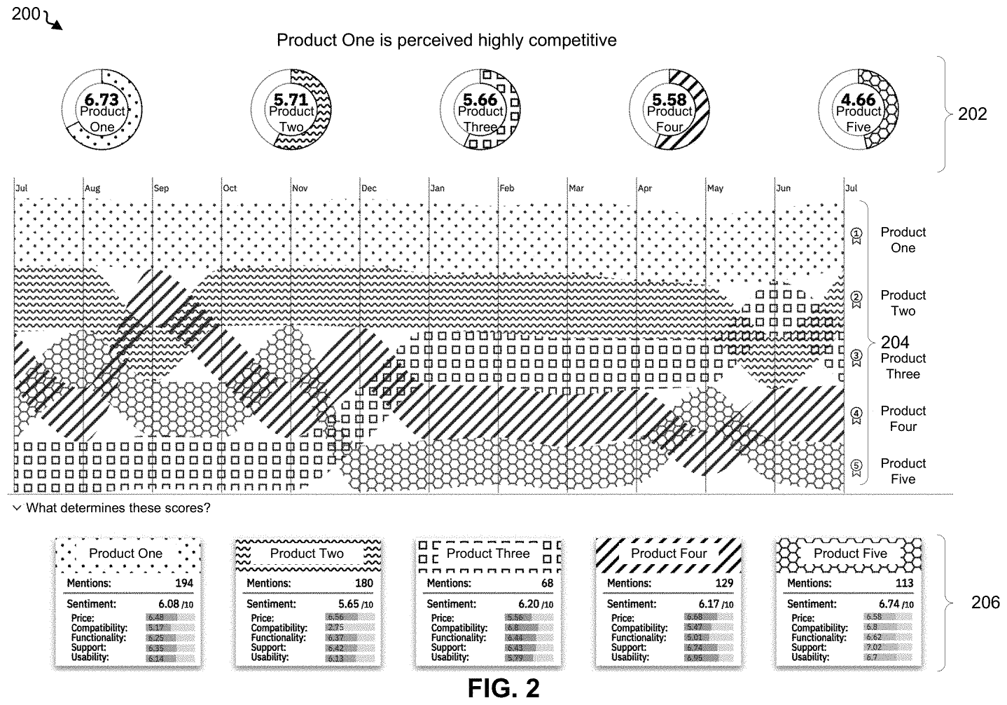

At operation 120, the competitive analysis application outputs product and/or service competitiveness data. The output at 120 will vary in embodiments and will depend on the nature of the calculations performed at operation 118. In some embodiments, the competitive analysis application can output a single numeric score for the received product or service and for each of its competitors to provide a quick answer at a glance of product and/or service competitiveness. In other embodiments, a sorted stream graph, such as sorted stream graph 200 shown in FIG. 2 below can be displayed as output to provide a user with detailed information including the scores of the products and/or services being compared over time and potentially with breakdowns of one or more of the scores used as factors in the calculations at operation 118. It should be understood that any or all of the information calculated during operation 118 can be output at operation 120 and can be output using various graphical, tabular, list, or other formats and be within the scope of this disclosure.

FIG. 2 depicts an example output of a computerized analysis of product and/or service competitiveness in the form of a sorted stream graph 200, in accordance with embodiments of the present disclosure. Sorted stream graph 200 can be the output of a competitive analysis application, such as the one which performed method 100 of FIG. 1 and the output at operation 120 described above. While sorted stream graph 200 is shown, it is for example purposes only and many modifications to it, or changes in the format of the output, are contemplated by this disclosure. A sorted stream graph, such as sorted stream graph 200, is an area graph which is displaced around a central axis, resulting in a flowing, organic shape and is sorted such that the highest value is the top stream.

In the example of sorted stream graph 200, the scores for the products are depicted in region 202. These scores in region 202 are presented are on a scale from 0 to 10, which can correspond to the percentile scores calculated during operation 118 of FIG. 1 after multiplying them by 10 (e.g., the example overall score of 0.72 above could be a score of 7.2 in sorted stream graph 200). In addition to numerical form, these scores are represented as portions of a circle, with the fill pattern of the circle corresponding to the fill pattern in region 204 (e.g., dotted, wavy lined, etc.).

Region 204 of sorted stream graph 200 shows the main sorted stream graph. The x-axis of sorted stream graph 200 represents time, as shown by the month names at the top of the graph. The y-axis of sorted stream graph 200 represents the numerical score associated with a product. The widths of the streams represent the proportion of score relative to the competition. The areas of cross-over between the streams indicate where one product changed in ranking relative to another. The aggregate width of all products shows market dynamics.

The lower region, 206, of sorted stream graph 200, below the downward caret and phrase “What determines these scores?” provides additional detail into the determination of the scores shown above and includes a breakdown for each product of the mentions (which can correspond to a volume factor), an overall sentiment score, and individual sentiment scores for the received dimensions (which in this example are price, compatibility, functionality, support, and usability). As represented by the downward caret, this area may be hidden until a user clicks on the phrase “What determines these scores?” and receives the additional information through their action. More or less information may be present in region 206 in embodiments.

Referring now to FIG. 3, illustrated is a block diagram of a computer system 300, in accordance with some embodiments of the present disclosure. In some embodiments, computer system 300 performs operations in accordance with FIG. 1 as described above. The computer system 300 can include one or more processors 305 (also referred to herein as CPUs 305), an I/O device interface 310 which can be coupled to one or more I/O devices 312, a network interface 315, an interconnect (e.g., BUS) 320, a memory 330, and a storage 340.

In some embodiments, each CPU 305 can retrieve and execute programming instructions stored in the memory 330 or storage 340. The interconnect 320 can be used to move data, such as programming instructions, between the CPUs 305, I/O device interface 310, network interface 315, memory 330, and storage 340. The interconnect 320 can be implemented using one or more busses. Memory 330 is generally included to be representative of a random access memory (e.g., static random access memory (SRAM), dynamic random access memory (DRAM), or Flash).

In some embodiments, the memory 330 can be in the form of modules (e.g., dual in-line memory modules). The storage 340 is generally included to be representative of a non-volatile memory, such as a hard disk drive, solid state device (SSD), removable memory cards, optical storage, or flash memory devices. In an alternative embodiment, the storage 340 can be replaced by storage area-network (SAN) devices, the cloud, or other devices connected to the computer system 300 via the I/O devices 312 or a network 350 via the network interface 315.

The CPUs 305 can be a single CPU, multiple CPUs, a single CPU having multiple processing cores, or multiple CPUs with one or more of them having multiple processing cores in various embodiments. In some embodiments, a processor 305 can be a digital signal processor (DSP). The CPUs 305 can additionally include one or more memory buffers or caches (not depicted) that provide temporary storage of instructions and data for the CPUs 305. The CPUs 305 can be comprised of one or more circuits configured to perform one or more methods consistent with embodiments of the present disclosure.

The memory 330 of computer system 300 includes competitive analysis application 332. Competitive analysis application 332 can be an application or compilation of computer instructions for performing competitive analysis of products and/or services. Competitive analysis application 332 can the competitive analysis application described above as performing method 100 of FIG. 1. Competitive analysis application 332 can receive product or service names and dimensions as input and ultimately output product and/or service competitiveness information in the form of scores, graphs, or other forms of output as appropriate.

Storage 340 contains product or service name and dimensions 342 and product review data 344. Product or service name and dimensions 342 can be the product or service name and dimensions input into computer system 300 and may be input into competitive analysis application 332 for performance of a competitive analysis method, such as method 100 of FIG. 1 above. The product or service name and dimensions 342 can be a product or service name for which competitive analysis is to be performed and may also include one or more competing products and/or services or information regarding such competitors. Product or service name and dimensions 342 also includes the dimensions input or selected by a user for performance of the method and can be e.g., price, compatibility, functionality, support, and usability.

Product review data 344 can be various types of data regarding the inputted product or service of Product or service name and dimensions 342 and can also include data regarding competing products and/or services. Product review data 344 can be obtained using APIs and/or web crawlers used to identify review data of products for analysis by competitive analysis application 332.

In some embodiments as discussed above, the memory 330 stores competitive analysis application 332, and the storage 340 stores product or service name and dimensions 342 and product review data 344. However, in various embodiments, each of the competitive analysis application 332, product or service name and dimensions 342, and product review data 344 are stored partially in memory 330 and partially in storage 340, or they are stored entirely in memory 330 or entirely in storage 340, or they are accessed over a network 350 via the network interface 315.

In various embodiments, the I/O devices 312 can include an interface capable of presenting information and receiving input. For example, I/O devices 312 can receive input from a user and present information to a user and/or a device interacting with computer system 300.

The network 350 can connect (via a physical or wireless connection) the computer system 300 with other networks, and/or one or more devices that interact with the computer system.

Logic modules throughout the computer system 300—including but not limited to the memory 330, the CPUs 305, and the I/O device interface 310—can communicate failures and changes to one or more components to a hypervisor or operating system (not depicted). The hypervisor or the operating system can allocate the various resources available in the computer system 300 and track the location of data in memory 330 and of processes assigned to various CPUs 305. In embodiments that combine or rearrange elements, aspects and capabilities of the logic modules can be combined or redistributed. These variations would be apparent to one skilled in the art.

FIG. 4 illustrates a block diagram of a network environment 400 in which some embodiments of the present disclosure can be implemented. The network 402 communicatively couples client computer 404, API enabled server 410, and server 420 to one another via a physical or wireless connection. Network 402 can be the Internet, a local area network, a wide area network, a wireless network, a combination of types of networks, and/or any other suitable network configuration.

Client computer 404 can be consistent with computer system 300 of FIG. 3 discussed above and can be a computer which runs a competitive analysis application, such as that used in performance of method 100 of FIG. 1. The form of client computer 404 can vary in embodiments and can include, but is not limited to, a desktop computer, a laptop, a tablet, a mobile phone, a server, or other computer device. In some embodiments, client computer 404 can access or interface with a competitive analysis application running on another device, including using cloud computing technology such as that discussed below with regard to FIGS. 5 and 6.

Client computer 404 can interact with API enabled server 410 through network 402 using an API 412, which can be a server-side API or a client-side API. API 412 can enable access to product or service data 414 stored on API enabled server 410. Client computer 404 can request product or service data 414 through the use of API 412 for use in performing competitive analysis, such as during operation 106 of method 100. Client computer 404 can also interact through network 402 with server 420, which does not contain an API. Client computer 404 can utilize one or more web crawlers in order to index and retrieve product or service data 424 for use in performing competitive analysis, such as during operation 106 of method 100.

While FIG. 4 shows a single network, one API enabled server 410, and one server 420 which is not API enabled, this is for representative purposes only. Much more complicated network environments 400 can exist and are contemplated by this disclosure, including with a plurality of API enabled servers, each with their own product or service data, and a plurality of other servers, each with their own product or service data. In such embodiments, client computer 404 may interact with some or all of such pluralities of servers to obtain large quantities of product or service data for competitive analysis.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and competitive analysis application 96. Competitive analysis application 96 can be a workload or function such as that described in FIG. 1 above.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But, the various embodiments can be practiced without these specific details. In other instances, well-known circuits, structures, and techniques have not been shown in detail in order not to obscure embodiments.

What is claimed is:

1. A computer-implemented method for competitive analysis, the method comprising:
receiving a product or service name for competitive analysis;
determining a plurality of dimensions for competitive analysis of the product or service;
collecting product or service data regarding a product or service associated with the product or service name and one or more competing products or services;
performing, using the plurality of dimensions, natural language processing on the collected product or service data;
calculating, using results of the natural language processing, a product or service competitiveness score; and
outputting the product or service competitiveness score.

2. The method of claim 1, wherein performing natural language processing further comprises:
extracting keywords from the collected product or service data.

3. The method of claim 2, further comprising:
converting the keywords and the plurality of dimensions to word vectors.

4. The method of claim 3, further comprising:
calculating distances between each of the keywords and each of the plurality of dimensions.

5. The method of claim 4, wherein calculating distances between each of the keywords and each of the plurality of dimensions includes calculating a cosine similarity between each of the keywords and each of the plurality of dimensions.

6. The method of claim 5, further comprising:
assigning each of the keywords to at least one of the plurality of dimensions using the distances;
extracting keyword sentiment values for each of the keywords; and
calculating a sentiment value for each of the plurality of dimensions based on the keyword sentiment values of the keywords assigned to each of the plurality of dimensions.

7. The method of claim 1, wherein calculating the product or service competitiveness score includes calculating scores for numeric ratings of the product or service and the one or more competing products or services, a volume of the product or service data relating to the product or service and the one or more competing products or services, and average sentiment values for product or service and the one or more competing products or services.

8. The method of claim 1, wherein calculating the product or service competitiveness score includes giving weight to scores of data with more recent scores of data receiving a higher weight.

9. The method of claim 1, wherein the plurality of dimensions are selected from the group consisting of: price, compatibility, functionality, support, and usability.

10. A system for competitive analysis, the system comprising:
one or more processors; and
a memory communicatively coupled to the one or more processors,
wherein the memory comprises instructions which, when executed by the one or more processors, cause the one or more processors to perform a method comprising:
receiving a product or service name for competitive analysis;
determining a plurality of dimensions for competitive analysis of the product or service;
collecting product or service data regarding a product or service associated with the product or service name and one or more competing products or services;
performing, using the plurality of dimensions, natural language processing on the collected product or service data;
calculating, using results of the natural language processing, a product or service competitiveness score; and
outputting the product or service competitiveness score.

11. The system of claim 10, wherein performing natural language processing further comprises:
extracting keywords from the collected product or service data.

12. The system of claim 11, further comprising:
converting the keywords and the plurality of dimensions to word vectors.

13. The system of claim 12, further comprising:
calculating distances between each of the keywords and each of the plurality of dimensions.

14. The system of claim 13, wherein calculating distances between each of the keywords and each of the plurality of dimensions includes calculating a cosine similarity between each of the keywords and each of the plurality of dimensions.

15. The system of claim 14, further comprising:
assigning each of the keywords to at least one of the plurality of dimensions using the distances;
extracting keyword sentiment values for each of the keywords; and
calculating a sentiment value for each of the plurality of dimensions based on the keyword sentiment values of the keywords assigned to each of the plurality of dimensions.

16. A computer program product for competitive analysis, the computer program product comprising a computer readable storage medium having program instructions embodied therewith, the program instructions executable by a computer to perform a method comprising:
receiving a product or service name for competitive analysis;
determining a plurality of dimensions for competitive analysis of the product or service;
collecting product or service data regarding a product or service associated with the product or service name and one or more competing products or services;
performing, using the plurality of dimensions, natural language processing on the collected product or service data;
calculating, using results of the natural language processing, a product or service competitiveness score; and
outputting the product or service competitiveness score.

17. The computer program product of claim 16, wherein calculating the product or service competitiveness score includes calculating scores for numeric ratings of the product or service and the one or more competing products or services, a volume of the product or service data relating to the product or service and the one or more competing products or services, and average sentiment values for product or service and the one or more competing products or services.

18. The computer program product of claim 16, wherein calculating the product or service competitiveness score includes giving weight to scores of data with more recent scores of data receiving a higher weight.

19. The computer program product of claim 16, wherein the plurality of dimensions are selected from the group consisting of: price, compatibility, functionality, support, and usability.

20. The computer program product of claim 16, wherein performing natural language processing further comprises:
extracting keywords from the collected product or service data;
converting the keywords and the plurality of dimensions to word vectors;
calculating distances between each of the keywords and each of the plurality of dimensions, wherein calculating distances between each of the keywords and each of the plurality of dimensions includes calculating a cosine similarity between each of the keywords and each of the plurality of dimensions;
assigning each of the keywords to at least one of the plurality of dimensions using the distances;
extracting keyword sentiment values for each of the keywords; and
calculating a sentiment value for each of the plurality of dimensions based on the keyword sentiment values of the keywords assigned to each of the plurality of dimensions.
